(19) United States
(12) Patent Application Publication
(10) Pub. No.: US 2026/0225735 A1
(43) Pub. Date: Aug. 6, 2026

(54) REUSABLE VEHICLE-ATTACHABLE OFF-LOADER

(71) Applicant: Blue Origin Manufacturing, LLC, Huntsville, AL (US)

(72) Inventor: Michael L. Gernhardt, Houston, TX (US)

(21) Appl. No.: 19/044,265

(22) Filed: Feb. 3, 2025

(51) Int. Cl. B64G 1/16; B64G 1/10; B64G 4/00

(52) U.S. Cl. CPC B64G 1/16; B64G 1/1071; B64G 2004/005

(57) ABSTRACT

An offloader and a number of techniques and systems that use the offloader for transporting cargo both to and from a lander on a surface of a moon or planet are presented. The offloader may be configured to work while docked with a terrain vehicle, such as a lunar terrain vehicle (STV). The offloader includes an extendable boom configured to reach the cargo on the lander. The extendable boom may include a magnetic end-effector to attach to a latching interface at a lift point on the cargo. The magnetic end-effector may allow for an initial soft-dock to a payload. Once magnetically coupled, a clamp may be actuated to establish a hard capture of the cargo for offloading.

### BACKGROUND

The Moon and other extra-terrestrial bodies (e.g., Mars) have been the focus of renewed interest in space exploration and long-term habitation. These activities will likely involve resources such as ascent vehicles, habitats, supplies, scientific packages, spare parts, and various commodities for fuel and life support to allow for a long-term human presence. Resources in the form of cargo may vary in volume and may range in mass from hundreds of kilograms to several metric tons or more. Thus arises a potential need for cargo handling, particular in relation to landers that bring the cargo into the lunar environment.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a perspective view of cargo transported by a lander being loaded or unloaded by an offloader that is docked with a surface terrain vehicle, according to some embodiments.

FIG. 2 is a perspective view of an offloader that is undocked with a surface terrain vehicle, according to some embodiments.

FIG. 3 is a perspective view of an offloader that is docked with a surface terrain vehicle, according to some embodiments.

FIG. 4 is a perspective view of an offloader that is docked with a surface terrain vehicle and holding cargo at the end of its boom, according to some embodiments.

FIG. 5 is a perspective view of the end of a boom of an offloader holding cargo, according to some embodiments.

FIG. 6 is a perspective view of the end-effector of a boom of an offloader engaged with an attachment point of cargo, according to some embodiments.

FIG. 7 is a block diagram of a control system for operating various aspects of an offloader, according to some embodiments.

FIG. 8 is a flow diagram of a process for handling cargo disposed on a lander on a surface of the Moon, according to some embodiments.

FIGS. 9-12 are schematic diagrams of a process of unloading an offloader from a lander, according to some embodiments.

FIGS. 13-16 are schematic diagrams of a process of unloading an offloader from a lander, according to other embodiments.

FIG. 17 is a flow diagram of a process of unloading an offloader from a lander, according to some embodiments.

FIG. 18 is a flow diagram of another process of unloading an offloader from a lander, according to other embodiments.

### DETAILED DESCRIPTION

This disclosure describes an offloader and a number of techniques and systems that use the offloader for transporting cargo both to and from a lander on a surface of a moon or planet. The offloader may also be used for a number of other activities, which are described below. The offloader is configured to work in conjunction with a surface terrain vehicle (STV), such as a lunar terrain vehicle (LTV). Embodiments are supported by examples that involve the Moon, but the offloader is not limited in this way and may operate, as described herein, at any other locations, such as Earth, other moons, and planets. Accordingly, claimed subject matter is not limited to operability on any particular planetary or lunar body. A terrain vehicle, which could be operated in locations other than the Moon, is referred to herein as an STV for convenience.

An STV may be similar in some ways to the lunar roving vehicle (LRV) that was used during the last three Apollo missions. The LRV was an electric-drive vehicle designed to operate in the low-gravity vacuum environment of the Moon and to be capable of traversing the lunar surface, allowing the Apollo astronauts to extend the range of their surface extravehicular activities (EVAs). An STV may be an unpressurized rover that astronauts can drive on the Moon while wearing their spacesuits. In some implementations, an STV need not be manned and can be remotely controlled. Accordingly, in general, an STV may include pressurized or unpressurized rovers and may be robotic or crew-tended. Claimed subject matter is not limited in these respects.

A lander, such as a lunar lander or Moon lander, is a spacecraft designed to land on the surface of a moon or planetary body, such as the Moon. For example, the Apollo Lunar Module was a lunar lander used in human spaceflight, completing six lunar landings from 1969 to 1972 during the United States'Apollo Program. Herein, a lander may be described in some examples as being on the Moon, but claimed subject matter is not limited to operability on any particular planetary or lunar body.

In some embodiments, an offloader may be transported to the Moon by a lander. For example, the offloader may be mounted on top of the lander upon arrival to the Moon. Subsequently, the offloader itself may be offloaded from the lander to the Moon's surface. Once offloaded to the lunar surface, the offloader may dock with an STV (which is already on the surface), thus forming a mobile offloading system for use in unloading cargo from other landers. An offloader being docked (e.g., physically attached or connected) to an STV is herein referred to as an offloader-STV system.

To be able to utilize payloads brought to the lunar surface, the payloads may not only need to be removed from the lander but may also need to be transported to another location for its intended use. The offloader-STV system may allow for both functions of cargo removal from a lander and cargo transport to another location on the lunar surface. For example, communications relay hardware may be delivered as cargo on a lander. This cargo may need to be relocated a substantial distance from the lander.

In some embodiments, an offloader for transporting cargo to or from a lander on a surface of a moon or planet may include a body, tracks or wheels below the body to enable the offloader to travel on the surface, a docking interface to enable the offloader to attach (e.g., dock) to an STV, and an extendable (e.g., telescoping, folding, etc.) boom on the body. The boom may be configured to reach the cargo on the lander. The extendable boom may include a magnetic end-effector configured to attach to a latching interface at a lift point on the cargo. For example, such a magnetic end-effector may allow for an initial soft-dock to a payload. Once magnetically coupled, a clamp may be actuated to establish a hard capture of the cargo for offloading. “Soft-dock” refers to an established connection between end-effector and cargo wherein the connection can only support a substantially limited, relatively low lifting force that is not sufficient for lifting the cargo. Soft-dock is generally useful for guiding the end-effector to a connection point of the cargo and holding that connection until a hard capture is established. “Hard capture” refers to an established connection between end-effector and cargo wherein the connection can support a force necessary for lifting the cargo.

The docking interface of the offloader may be a mechanical interface that connects the body of the offloader to the STV and allows the STV to control and drive the docked offloader to various locations. The docking interface may also, or instead, be a control interface that allows the STV to operate the extendable boom.

In some implementations, the offloader may also include outriggers that are deployable to maintain contact with the ground (e.g., Moon surface) and stabilize the body and boom during operations of the extendable boom. The outriggers may be configured to retract or fold into or toward the body, as described below. The docking interface may include a control interface that allows the STV to operate the extendable boom and the outriggers.

In some implementations, the offloader may also include a wireless (or wired) receiver and controller to enable the tracks or wheels, the extendable boom, and the outriggers to be controlled remotely from the STV or elsewhere (e.g., a lander). Also, the offloader may include machine vision and proximity detection to enable the offloader to autonomously drive to, and dock with, the STV. In some implementations, a portion of the extendable boom, such as the end-effector, may include machine vision and proximity detection to enable the end-effector to autonomously connect with a lift point of the cargo. In further implementations, the STV may include a positioning system that enables the STV to determine its position relative to, among other things, the lift point of the cargo. With this, the STV may determine the position of the end-effector relative to the lift point of the cargo by modelling the real-time configuration of the extendable boom, such as how much and at what angle the boom (and thus the end-effector) is extended.

Due to a number of reasons, in some situations, a crew may only be able to stay on a surface of the Moon (e.g., or planet) for a few days. The STV, however, could stay and be used for a much longer time period and be used for versatile functions/activities such as setting up infrastructure, moving objects, tanks, etc. The STV may be self-sufficient and may offer a type of universal operability and services that prepare for arrival of personnel and/or equipment, for example.

In some embodiments, a method for handling cargo disposed on a lander on a surface of the Moon may include transmitting wireless (or wired) signals from an STV to an offloader. The signals may include instructions for i) controlling the offloader to drive to the STV and attach to a work package interface on the STV, ii) controlling outriggers on the offloader to deploy the outriggers to contact the surface, and iii) controlling an extendable boom on the offloader to extend to the cargo disposed on the lander. The work package interface on the STV may be an interface that includes mechanical and electrical connections between the STV and the offloader. Controlling the offloader to drive to the STV may involve controlling wheels or tracks on the offloader for steering and moving the offloader on the ground. Controlling the extendable boom on the offloader may involve operating a magnetic end-effector that is attachable to a latching interface at a lift point on the cargo.

As mentioned above, upon arriving on a lander to the Moon's surface, the offloader itself may be offloaded from the lander. This offloading process may involve a truss system or other such support structure that is located on an upper portion of the lander. An extendable boom of the offloader may include a hook or similar type of end-effector. The truss system may include an overhead part, such as a loop or opening, that can be hooked by the hook of the extendable boom. While hooked to the truss system, the offloader may effectively hang from the truss system via the extendable boom, particularly if the extendable boom retracts (e.g., shortens in length) and pulls the offloader upward. The truss system may pivot at its base and rotate so that the offloader is hanging outside the perimeter of the lander. The extendable boom may then extend until the offloader (hanging by the boom) reached down to the Moon's surface. After the hook detaches from the truss and the boom retracts, the process of offloading the offloader may be complete. This process is described in more detail below.

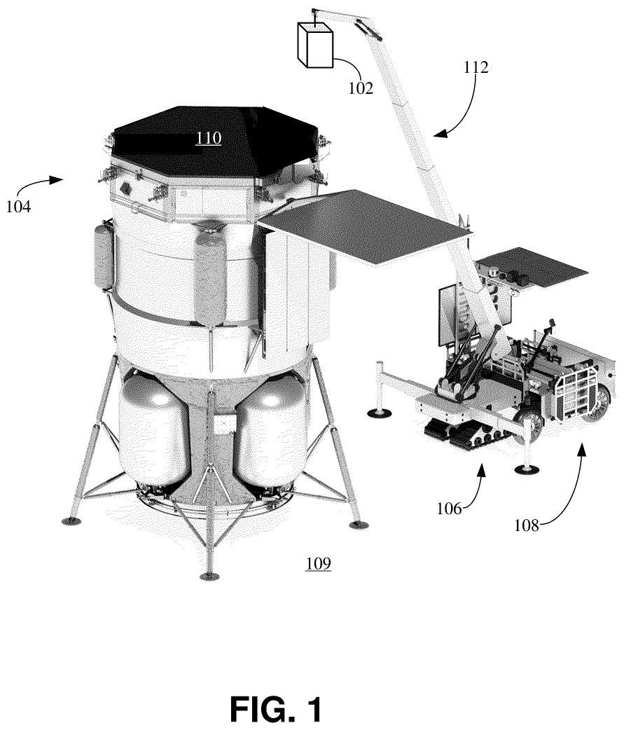

FIG. 1 is a perspective view of cargo 102 having been transported by a lander 104 being unloaded by an offloader 106 that is docked with an STV 108 on a surface 109 (e.g., of the Moon), according to some embodiments. Herein, though examples and processes of unloading are described, claimed subject matter may also include processes of loading, such as an offloader loading cargo onto a lander. Accordingly, even though an “offloader” is described, claimed subject matter is not limited to processes of offloading.

Lander 104 may include a cargo platform 110 on an upper portion of the lander. For example, the lander may carry cargo 102 that is secured on the cargo platform. Accordingly, for offloading, offloader 106 may include an extendable boom 112 that can extend to reach lift points of cargo on the cargo platform. Lift points may generally be located vertically above the center of mass of the cargo, though claimed subject matter is not limited in this respect.

FIG. 2 is a perspective view of offloader 106 that is undocked with STV 108, according to some embodiments. Offloader 106 may include extendable boom 112, outriggers 202, and tracks 204. For example, tracks 204 may allow for movement of offloader 106 on a surface 206 (e.g., of the Moon). In some implementations, wheels instead of tracks 204 may be used. Offloader 106 may also include a docking interface 208 to enable the offloader to dock with STV 108 via a corresponding work package interface 210 on the STV. For example, work package interface 210 may provide structural, power, data, and/or thermal support to offloader 106 via docking interface 208.

In some embodiments, rotational speed and/or direction of tracks 206 (or wheels) of offloader 106 may be remotely controlled to steer and move the offloader toward STV 108 for docking. For example, arrow 212 indicates a motion of offloader 106 closing a gap between it and STV 108 for docking, which may occur upon or after docking interface 208 of the offloader comes into contact with work package interface 210 of the STV.

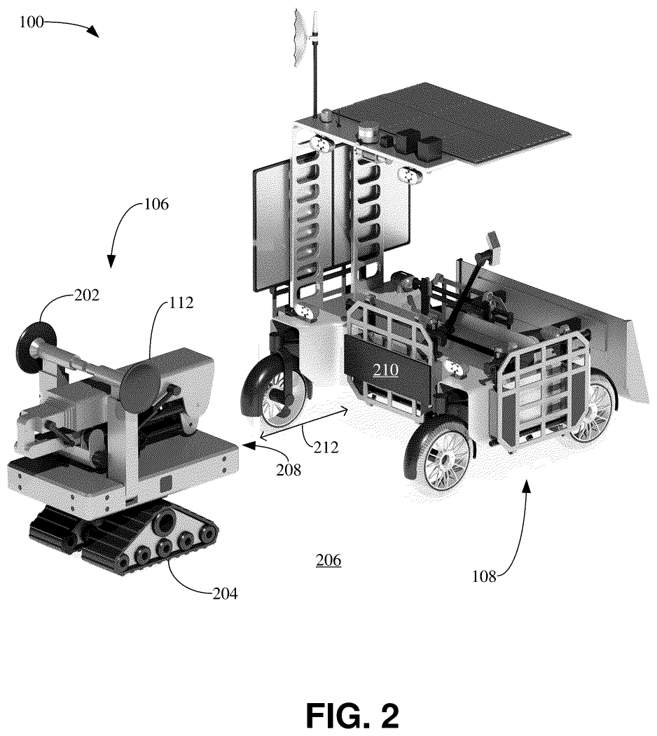

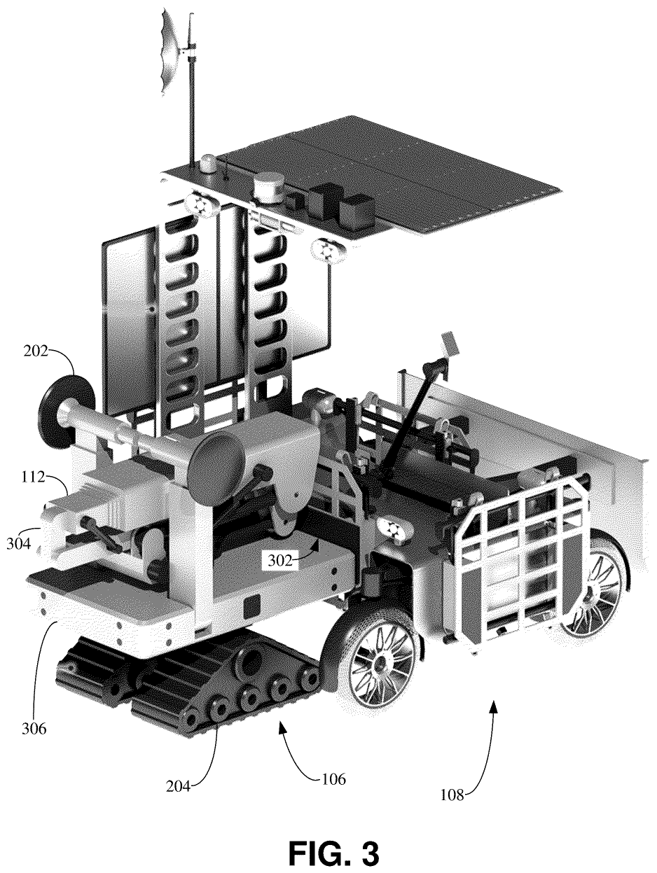

FIG. 3 is a perspective view of offloader 106 that is docked with STV 108, according to some embodiments. For example, docking is made via a connection 302, which may be mechanical and/or electrical, between docking interface 208 of the offloader and work package interface 210 of the STV. In some implementations, connection 302 may enable the transfer, in one or both directions, of structural support, power, data, and/or thermal support between offloader 106 and STV 108. While docked in this way, offloader 106 may be operated by systems of STV 108. Such systems may be controlled by crew (e.g., one or more persons) onboard STV 108. In particular, various parts and functions of offloader 106 may be operated from the STV. For example, from the STV, crew therein may operate extendable boom 112 to extend or retract, rotate, or pivot so as to reach cargo on a lander (e.g., 104). The crew may also operate an end-effector 304 at or near the end of boom 112.

The crew in the STV may also operate outriggers 202 to deploy them from their stored position on the body 306 of offloader 106, as illustrated in FIG. 3. Outriggers 202 are deployed when they are in contact with the ground (e.g., surface of the Moon). Deployed outriggers 202 provide stability to offloader 106, particularly while extendable boom 112 is extended.

In some embodiments, the docking made via connection 302 between docking interface 208 of the offloader and work package interface 210 of the STV may be mechanically robust to support loads corresponding to the weights of the offloader, the STV, and cargo 102. For example, during boom operations, while outriggers 202 are deployed (e.g., in contact with the ground), at least a portion of the offloader may be lifted off the ground by the outriggers. Additionally, the STV may also be at least partially lifted off the ground by the outriggers. In this case, the outriggers on the offloader are lifting the STV via work package interface 210. Thus, this interface may necessarily be mechanically robust to support such a transfer of lifting forces. In other words, outriggers 202 of offloader 106 may lift at least a portion of STV 108 via docking interface 302. The lifting of the STV with the offloader may provide additional support and stability during boom operations, for example.

In some embodiments, STV 108, like offloader 106, may include outriggers, which may be on a part of the body of STV 108, as indicated by arrow 308 (an additional outrigger may be on the opposite side of the STV body). The Moon's gravity is only about ⅙th of Earth's gravity. Accordingly, offloader 106 may be relatively lightweight and stability during boom operations may benefit if the additional weight of STV 108 is included by deployment of its outriggers. For example, including at least a portion of the weight of the STV could increase the stability and traction of the offloader-STV system.

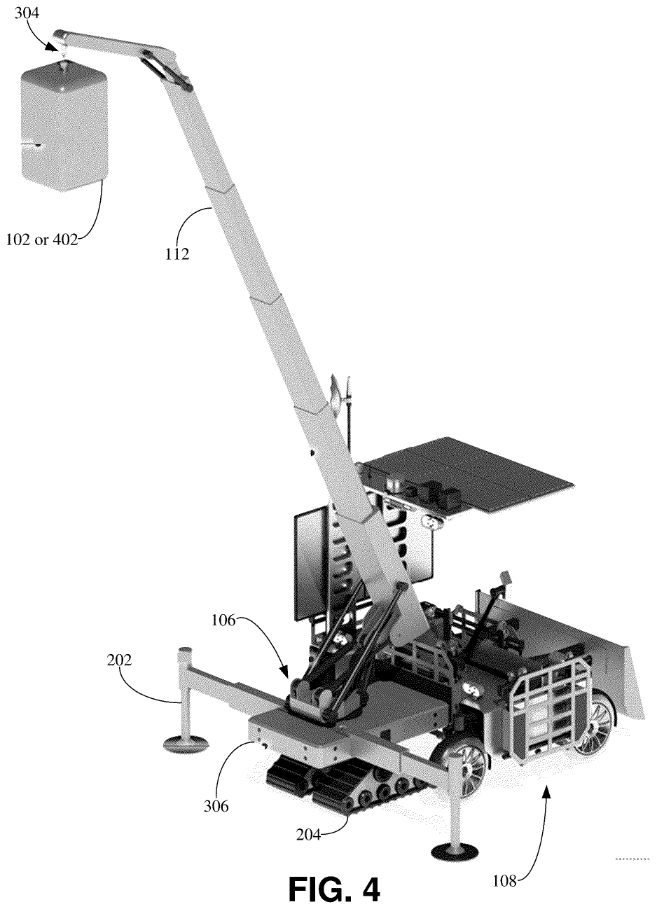

FIG. 4 is a perspective view of offloader 106 that is docked with STV 108 and holding cargo 102 at the end of extendable boom 112, according to some embodiments. Outriggers 202 are deployed for stability during loading or offloading of cargo.

In some implementations, offloader 106 may be equipped with a crew basket supported by a connection system in place of, or in addition to, end-effector 304. The crew basket may have a size to safely hold one or two people. For example, such an implementation may be visualized with FIG. 4 if cargo 102 is replaced by a crew basket 402 (e.g., a crew basket may look similar to cargo 102 as illustrated). Offloader 106 equipped with a crew basket may be used for doing maintenance on objects or systems that are relatively high off the ground but reachable by extendable boom 112. In another example, the offloader with a crew basket may be used to elevate crew for observation and/or sampling of large and tall geological structures or to allow the crew to access steep craters, pits, etc.

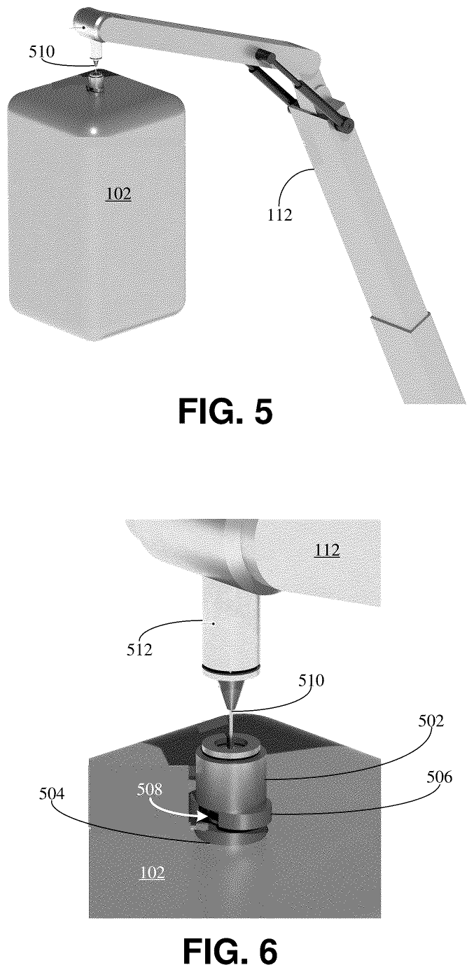

FIG. 5 is a perspective view of the end region of extendable boom 112 of offloader 106 holding cargo 102 and FIG. 6 is a close-up view of this region, according to some embodiments. Cargo 102 may be configured to be lifted by including a feature on its upper surface to facilitate secure and precise engagement with a magnetic end effector 502 of boom 112. This feature may take the form of a magnetic alignment guide, pickup feature, or engagement structure, configured to interact with the end effector. For instance, the feature could include a small extension capable of magnetically attracting the end effector, ensuring accurate positioning and alignment during a lifting process. In one example, this feature might be shaped like a mushroom to provide a raised, centralized point of attachment, offering both magnetic and mechanical engagement. Alternatively, the feature may be a plate elevated slightly above the cargo's surface, allowing a portion of the end effector to slide underneath for a secure grip. This elevated design may minimize interference with the cargo itself while providing a robust attachment point for lifting. Other configurations might involve a load attachment feature with magnetic responsiveness or mechanical compatibility to meet various operational needs. The flexibility in design ensures compatibility with different types of end effectors and lifting mechanisms, enabling reliable and efficient handling of the cargo.

In various implementations, boom 112 may include magnetic (e.g., an electromagnetically energizeable) end-effector 502 for initial soft-docking to the cargo. For example, cargo 102 may include a payload-mounted latching interface 504 (e.g., the “feature” described above) that can magnetically attract magnetic end-effector 502. Thus, when the end of boom 112 places its end-effector 502 relatively close to cargo 102, latching interface 504 may laterally pull and guide, via magnetism, the end-effector toward the latching interface. Accordingly, this magnetic interaction can assist in the process of attaching the end-effector onto the cargo.

Upon or after end-effector 502 is magnetically coupled to latching interface 504, a clamp 506 of the latching interface may be actuated to establish a hard capture by the end-effector of the cargo for offloading the cargo. For example, a hard capture may involve clamp 506 sliding horizontally over a distal end 508 of end-effector 502 so that clamp 506 holds the distal end in place. In another example, a hard capture may involve clamp 506 sliding at least partially below latching interface 504 so that the clamp attaches or connects distal end 508 to the latching interface. In these configurations, the end-effector is retained by the cargo, which may be lifted by the boom. In some implementations, end-effector 502 may be attached to boom 112 by a cable 510 connected to a cable interface 512, though claimed subject matter is not limited to such a configuration. In some implementations, cable 510 may be used in conjunction with a snubber, which is a device designed to control or dampen movement to prevent unwanted motion and reduce the impact of sudden forces, for example. The snubbers may be used to stabilize loads, absorb shock, and protect both the load and the lifting equipment.

Magnetic end-effector 502 and associated parts (e.g., the magnetic end-effector system), such as latching interface 504 and clamp 506, as well as their method of attaching to cargo or other masses, may be applied to any of a number of applications. In other words, the magnetic end-effector system and applications thereof are not limited to the offloader described herein. The magnetic end-effector system may be applied to knuckle booms, telescoping booms, folding booms, articulating booms, extendable booms, and fixed booms, just to name a few examples. Such implementations may generally use lines such as cable 510 that provide compliance (e.g., swinging) as the magnetism of end-effector 502 “seeks” a latching interface (e.g., 504). In other implementations, such as robotic arms, compliance may be provided by various systems (e.g., methods and configurations). For example, a system may include elastic elements, wherein springs (e.g., damped springs) may be attached to a robotic arm's end-effector or joints to allow compliant movement. This can mimic the freedom of a crane cable. In another example, materials with inherent flexibility (e.g., silicone, polymers) or soft robotic joints may allow compliant movement. In yet another example, compliant structures, such as flexure mechanisms (e.g., spring steel), can bend or deform.

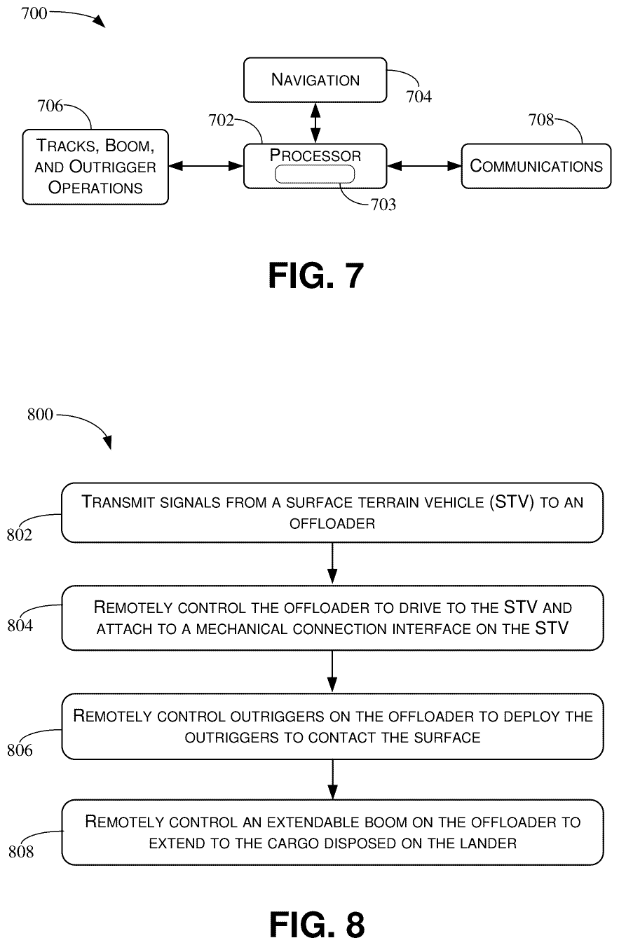

FIG. 7 is a block diagram of a control system 700 for operating various aspects of an offloader, such as 106, according to some embodiments. Processor 702 may include any type of computing device having one or more processing units operably connected to computer-readable media 703. The computer-readable media may include two types of computer-readable media, namely computer storage media and communication media. Computer storage media may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. Communication media may embody computer-readable instructions, data structures, program modules, or other data in a modulated data signal, such as a carrier wave, or other transmission mechanism.

In some examples, computer-readable media 703 may store instructions executable by processor 702. Computer-readable media 703 may also store instructions executable by an external CPU-based processor, executable by a GPU, and/or executable by an accelerator, such as an FPGA-based accelerator, a DSP-based accelerator, or any internal or external accelerator, just to name a few examples. Executable instructions stored on computer-readable media 703 may include, for example, an operating system and other modules, programs, or applications that may be loadable and executable by processor 702.

Navigation block 704 may be configured to interface between processor 702 and any number of navigation devices, such as an accelerometer, a gyrocompass, a magnetometer, position and orientation sensors, as well as access to map data, telemetry data, and so on. Other navigation devices may include sonar (for operations in an atmosphere) and lidar for real-time ground measurements, such as the lunar surface, and also distance and/or position measurements of an STV (e.g., 108) with respect to the docking interface (e.g., 208) of the offloader and/or the work package interface (e.g., 210) of the STV. For example, navigation block 704 may include a laser telemeter on the offloader may detect a position of the STV for docking thereto. In another example, navigation block 704 may include machine vision and proximity detection to enable the offloader to autonomously drive to, and dock with, the STV. In some implementations, a portion of the extendable boom, such as the end-effector, may include machine vision and proximity detection at least partially controlled by navigation block 704 to enable the end-effector to autonomously connect with a lift point of the cargo.

Operations block 706 may be configured to interface between processor 702 and tracks 204, boom 112, and outriggers 202, for example. For example, processor 702 may provide commands to block 706 to control steering and movement of the offloader actuated by tracks 204, length and angle of extendable boom 112, and deployment (or non-deployment) of outriggers 202. Processor 702 may use information collected by navigation block 704 to generate commands for operations block 706.

Communications block 708 may be configured to receive remote (e.g., wireless) instructions to be performed by the offloader. Communications block 708 may include a receiver and transmitter and an interface to processor 702. Accordingly, processor 702 may receive executable code from an outside source or transmit executable code to an outside entity (e.g., report positioning of boom, end-effector status, outriggers, etc.). In some implementations, the offloader may operate autonomously but may receive wireless instructions, via the receiver of communications block 708, for controlling or modifying a cargo offloading process or may receive updated navigation data measured and/or collected by remote entities (e.g., a lander, an STV, or a ground station that measures local environmental data).

FIG. 8 is a flow diagram of a process 800 that uses an offloader for handling cargo disposed on a lander on a surface of the Moon, according to some embodiments. For example, the process may be performed autonomously, locally, or remotely by an operator, which is herein considered to be an electronic controller, a computer processing system following computer-executable instructions, an operator such as a person on a space vehicle (e.g., STV) or at a remote control center, or a combination thereof.

At 802, the operator may transmit wireless or wired signals from an STV to the offloader. For example, referring to FIG. 7, communications block 708 on the offloader may receive the wireless signals and provide them to processor 702 for controlling various parts of the offloader. In particular, the wireless signals may include instructions, as in 804, for controlling (from the STV) the offloader to drive to the STV and attach to a work package interface (e.g., 210) on the STV. The wireless signals may also include, as in 806, instructions for controlling (from the STV) outriggers on the offloader to deploy the outriggers to contact the ground for stability. The wireless signals may also include, as in 808, instructions for controlling (from the STV) an extendable boom (e.g., 112) on the offloader to extend to the cargo disposed on the lander.

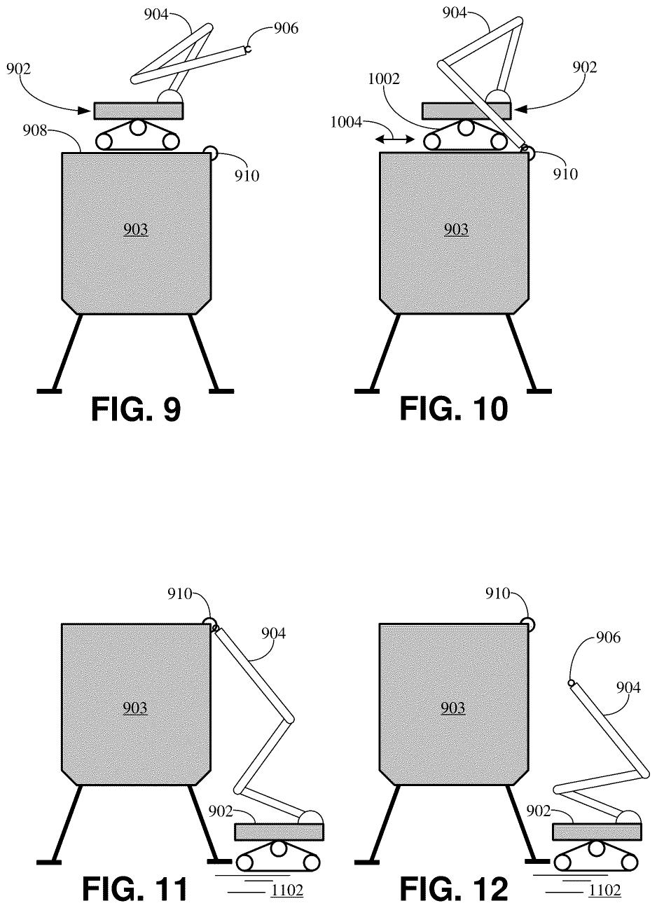

FIGS. 9-12 are schematic diagrams that illustrate a process of unloading an offloader 902 from a lander 903, according to some embodiments. Such a process may occur when an offloader is delivered to the Moon (or other location) by a lander. In some of these embodiments, offloader 902 rides on a cargo platform (e.g., 110) on an upper portion of lander 903. Thus, upon arriving to the Moon on the lander, the offloader itself may be offloaded from the lander to the Moon's surface (e.g., ground).

Referring to FIG. 9, offloader 902 includes, among other things, an extendable boom 904 with an end-effector 906, which may be configured as a hook, for example. Offloader 902 may be the same as or similar to offloader 106, for instance. Offloader 902 may be disposed and secured (e.g., retained) on a cargo platform 908 on an upper portion of lander 903. In some implementations, straps or other retaining devices may secure the offloader for its flight on the lander. Such retention measures, however, may be removed at or near the beginning of the process of offloading the offloader.

In some implementations, lander 903 may include a grab loop 910 (e.g., hoist ring, anchor point, attachment loop, etc.) that is configured to receive and hold hook-shaped end-effector 906, for example. Loop 910, which may be located in or on parts of the lander other than that illustrated in the figure, may have any of a number of configurations that allow for an end-effector to attach (e.g., hook) thereon, and claimed subject matter is not limited in these respects.

Referring to FIG. 10, using tracks or wheels 1002, offloader 902 may be moved (autonomously, for example), as indicated by arrows 1004, on cargo platform 908 so that hook-shaped end-effector 906 of extendable boom 904, being appropriately configured, can reach loop 910. Upon or after the end-effector hooks into (or onto) loop 910, the extendable boom may re-configured (e.g., extending, retracting, or rotating sections to achieve a new configuration) so that the loop, end-effector, and boom may support the weight of the offloader. In other words, offloader 902 may lift and reposition itself from cargo platform 908.

Referring to FIG. 11, extendable boom 904 may be repositioned so as to lower offloader 902 past the edge of the lander and onto ground 1102 (e.g., Moon surface). Referring to FIG. 12, end-effector 906 may unhook from loop 910 and extendable boom 904 may be reconfigured for storage or future offloading tasks, for example. At this stage, offloader 902 has been offloaded.

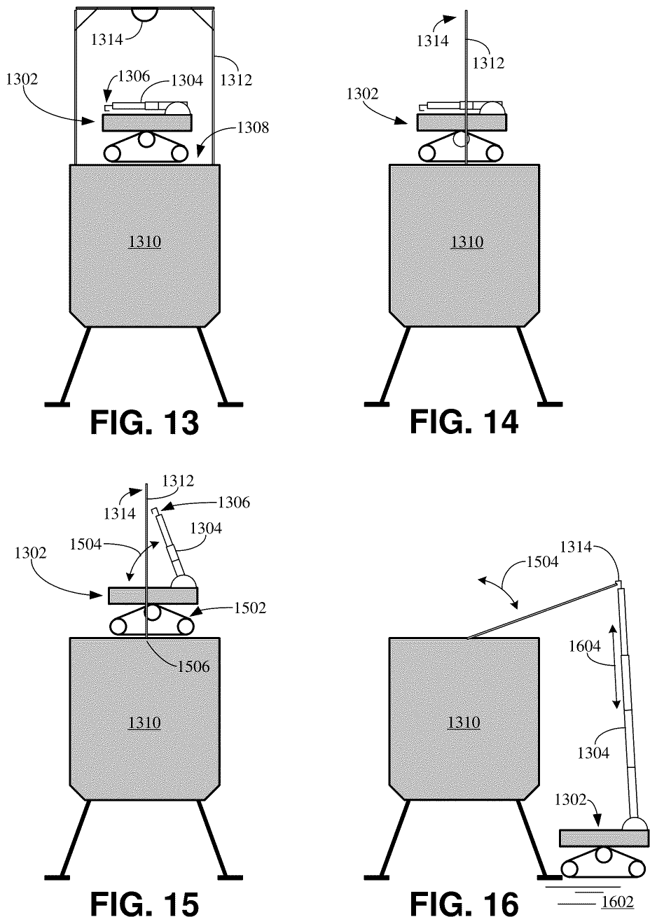

FIGS. 13-16 are schematic diagrams that illustrate a process of unloading an offloader from a lander, according to some embodiments. Such a process may occur when an offloader is delivered to the Moon (or other location) by a lander. In some of these embodiments, the offloader rides on a cargo platform (e.g., 110) on an upper portion of the lander. Thus, upon arriving to the Moon on the lander, the offloader itself may be offloaded from the lander to the Moon's surface (e.g., ground).

Referring to FIG. 13, an offloader 1302 includes, among other things, an extendable boom 1304 with an end-effector 1306. Offloader 1302 may be the same as or similar to offloader 106, for example. Offloader 1302 may be disposed and secured on a cargo platform 1308 on an upper portion of a lander 1310. For instance, straps or other retaining devices may secure (e.g., retain) the offloader for its flight on the lander. These retention measures, however, may be removed at or near the beginning of the process of offloading the offloader.

In some implementations, lander 1310 may include a truss system 1312 that supports an overhead loop 1314, which may be configured to receive and hold a hook-shaped end-effector 1306, for example. Loop 1314 may have any of a number of configurations that allow for an end-effector to attach (e.g., hook) thereon, and claimed subject matter is not limited in this respect. FIG. 10 is a side view of what's illustrated in FIG. 13, except that offloader 1302 is rotated in this view for illustrative clarity.

Referring to FIG. 15, using tracks or wheels 1502, offloader 1302 may be moved (autonomously, for example) on cargo platform 1308 so that hook-shaped end-effector 1306 of extendable boom 1304, being extended, can reach overhead loop 1314. Upon or after the end-effector hooks into (or onto) loop 1314, the extendable boom may retract enough so that the loop, end-effector, and boom are supporting the weight of the offloader. In other words, offloader 1302 lifts itself from cargo platform 1308. Subsequently, truss system 1312 may rotate, as indicated by arrow 1504, about a pivot point 1506 at or near the base of the truss system.

Referring to FIG. 16, truss system 1312 may rotate so that offloader 1302 is past the edge of the lander and is hanging from the truss system over the ground 1602 (e.g., Moon surface). Next, extendable boom 1304 may extend (e.g., lengthen), as indicated by arrow 1604, until the hanging offloader reaches the ground. End-effector 1306 may unhook from loop 1314 and the extendable boom may retract (e.g., shorten). At this stage, offloader 1302 has been offloaded.

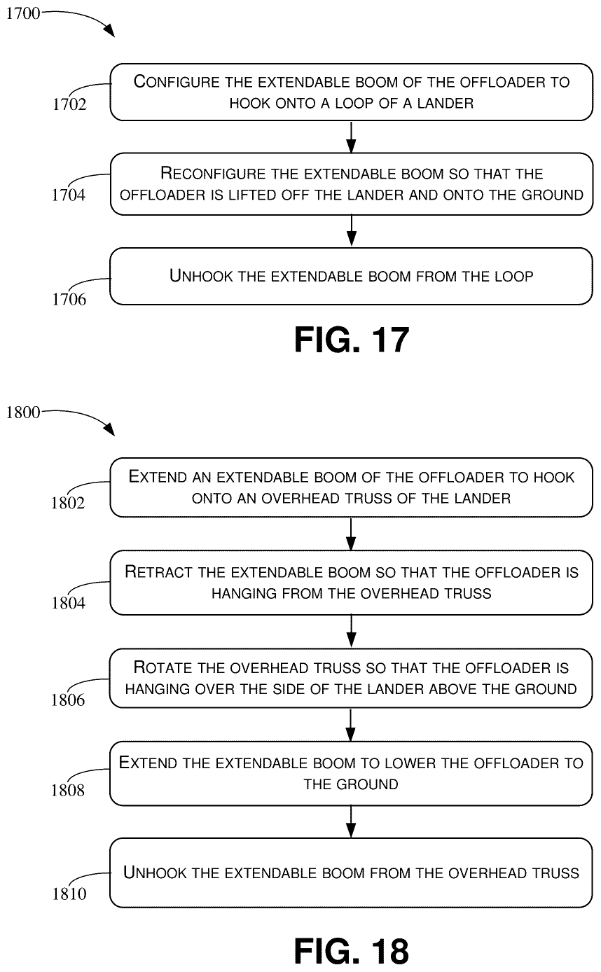

FIG. 17 is a flow diagram of a process 1700 of unloading offloader 902 from lander 903, according to some embodiments. For example, the process may be performed autonomously, locally, or remotely by an operator, which is herein considered to be an electronic controller, a computer processing system following computer-executable instructions, a person on a space vehicle (e.g., STV or the lander) or at a remote control center, or a combination thereof.

At 1702, the operator may configure extendable boom 904 of offloader 902 to hook onto loop 910 of lander 903. At 1704, the operator may reconfigure the extendable boom so that the offloader is lifted off the lander and onto the ground. At 1706, the operator may unhook the extendable boom from loop 910.

FIG. 18 is a flow diagram of a process 1800 of unloading offloader 1302 from lander 1310, according to some embodiments. For example, the process may be performed autonomously, locally, or remotely by an operator, which is herein considered to be an electronic controller, a computer processing system following computer-executable instructions, a person on a space vehicle (e.g., STV or the lander) or at a remote control center, or a combination thereof.

At 1802, the operator may extend extendable boom 1304 of offloader 1302 to hook onto overhead truss 1312 of lander 1310. At 1804, the operator may retract the extendable boom so that the offloader is hanging from the overhead truss. At 1806, the operator may rotate the overhead truss so that the offloader is hanging over the side of the lander above the ground (e.g., 1602). At 1808, the operator may extend the extendable boom to lower the offloader to the ground. At 1810, the operator may unhook the extendable boom from the overhead truss.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. An offloader for transporting cargo to and from a lander on a surface of a moon or planet, the offloader comprising:
a body;
tracks or wheels below the body to enable the offloader to travel on the surface;
a docking interface to enable the offloader to attach to a surface terrain vehicle (STV); and
an extendable boom on the body and configured to reach the cargo on the lander.

2. The offloader of claim 1, wherein the docking interface comprises a mechanical interface that connects the body of the offloader to the STV and allows the STV to drive the offloader to various locations.

3. The offloader of claim 1, wherein the docking interface comprises a control interface that allows the STV to operate the extendable boom.

4. The offloader of claim 1, further comprising outriggers that are deployable to contact the surface and stabilize the body during operations of the extendable boom, wherein the outriggers are configured to retract or fold into or toward the body.

5. The offloader of claim 4, wherein the docking interface comprises a control interface that allows the STV to operate the extendable boom and the outriggers.

6. The offloader of claim 4, further comprising a receiver and controller configured to enable the tracks or wheels, the extendable boom, and the outriggers to be controlled remotely from the STV.

7. The offloader of claim 1, wherein the extendable boom includes a magnetic end-effector configured to attach to a latching interface at a lift point on the cargo.

8. An offloader for transporting cargo to and from a lander on a surface, the offloader comprising:
tracks or wheels to enable the offloader to travel on the surface;
a mechanical interface configured to attach to a surface terrain vehicle (STV) so that the offloader is physically connected to the STV;
an extendable boom configured to extend to the cargo on the lander; and
outriggers to stabilize the offloader and the STV while the extendable boom is extended.

9. The offloader of claim 8, wherein the mechanical interface enables the STV to drive the offloader to various locations.

10. The offloader of claim 8, further comprising a receiver and controller configured to receive signals from the STV for controlling operations of the tracks or wheels, the extendable boom, and deployment of the outriggers.

11. The offloader of claim 8, wherein the outriggers are configured to retract or fold into or toward a chassis portion of the offloader.

12. The offloader of claim 8, wherein the extendable boom includes a magnetic end-effector configured to attach to a latching interface at a lift point on the cargo.

13. The offloader of claim 12, further comprising machine vision and proximity detection to enable the magnetic end-effector to autonomously connect with the cargo.

14. The offloader of claim 8, further comprising machine vision and proximity detection to enable the offloader to autonomously drive to, and connect with, the STV.

15. A method for handling cargo disposed on a lander on a surface of a moon or planet, the method comprising
transmitting signals from a terrain vehicle to an offloader, the signals including instructions for:
controlling the offloader to drive to the terrain vehicle and attach to a work package interface on the terrain vehicle;
controlling outriggers on the offloader to deploy the outriggers to contact the surface; and
controlling an extendable boom on the offloader to extend to the cargo disposed on the lander.

16. The method of claim 15, wherein controlling the offloader to drive to the terrain vehicle comprises controlling wheels or tracks on the offloader for steering and moving the offloader on the surface.

17. The method of claim 15, wherein the work package interface on the terrain vehicle includes mechanical and electrical connections between the terrain vehicle and the offloader.

18. The method of claim 15, wherein controlling the extendable boom on the offloader comprises operating a magnetic end-effector that is attachable to a latching interface at a lift point on the cargo.

19. The method of claim 18, wherein operating the magnetic end-effector includes using machine vision and proximity detection.

20. The method of claim 15, wherein the terrain vehicle is unmanned.
